(19) United States
(12) Patent Application Publication
(10) Pub. No.: US 2002/0141175 A1
(43) Pub. Date: Oct. 3, 2002

(54) Technique for indicating the presence of a medicinal substance

(76) Inventor: Lory A. Suby, Roscoe, IL (US)

Correspondence Address: Robert A. Van Someren, Fletcher, Yoder & Van Someren, P.O. Box 692289, Houston, TX, 77269-2289, US

(21) Appl. No.: 09/818,343

(22) Filed: Mar. 27, 2001

(51) Int. Cl. F21V 33/00; F21V 9/16

(52) U.S. Cl. 362/84; 362/101; 362/154

(57) ABSTRACT

A technique for enhancing the visibility of providing certain containers. The technique comprises providing a container that may be used for holding a medicinal substance. The container utilizes a light-emitting region, such as a luminescent region, to provide greater visibility, particularly when the container is located in a dim or dark environment.

### FIELD OF THE INVENTION

The present invention relates generally to containers, and more particularly to containers having a visual indicator.

### BACKGROUND OF THE INVENTION

Medications and other substances commonly are placed in a variety of containers in many different forms, including liquid, capsule, tablet, powder, etc. Some of these medications are used by individuals or practitioners in low light conditions. For example, individuals may need to take a medication during the night under low light conditions. Additionally, many medical practitioners, such as ophthalmologists, may perform a variety of examinations and/or treatments in low light conditions, e.g. a dark examination room, to facilitate a given procedure. Under these low light conditions, the practitioners must select the container or containers having an appropriate medication for the patient. Conventional containers are difficult to select in such low light conditions, particularly when placed in proximity to a variety of other containers.

Another problem with conventional containers is that there is limited product distinction, particularly when the product is used in low light conditions. In other words, the manufacturer or distributor of a given drug has limited ability to distinguish its product under these conditions. Accordingly, it would be advantageous to provide a container that is more readily discernable even in a dark environment.

### SUMMARY OF THE INVENTION

The present invention relates generally to a technique of rendering more visible a container of certain substances, such as medicinal substances. The technique utilizes the emission of light from at least a portion of the container to make the container more visible to an individual seeking a specific substance.

### BRIEF DESCRIPTION OF THE DRAWINGS

The invention will hereafter be described with reference to the accompanying drawings, wherein like reference numerals denote like elements, and:

FIG. 1 is a front elevational view of a container according to one embodiment of the present invention;

FIG. 2 is an alternate embodiment of the container illustrated in FIG. 1;

FIG. 3 is an alternate embodiment of the container illustrated in FIG. 1;

FIG. 4 is a front elevational view of the container illustrated in FIG. 1 showing a medicinal substance therein;

FIG. 5 is an alternate embodiment of the container illustrated in FIG. 4;

FIG. 6 is an alternate embodiment of the container illustrated in FIG. 1;

FIG. 7 is an exploded view of the container illustrated in FIG. 6; and

FIG. 8 is another alternate embodiment of the container illustrated in FIG. 1.

### DETAILED DESCRIPTION OF THE PREFERRED EMBODIMENTS

The present invention relates generally to a container for holding a substance, such as a medicinal substance. The container comprises a light-emitting region to make the container more readily visible in a dim or dark environment. The light-emitting region makes the desired container more visible to an individual who may be using the medication at night or to a medical practitioner, such as an ophthalmologist, that may be applying or otherwise using the medication in a relatively dim or dark environment. Various other individuals may benefit from the enhanced visibility.

The light-emitting region also can serve as a marketing tool for the distributor or manufacturer of a given medication by making the container more noticeable, e.g. more visible relative to other containers that may be located in close proximity. A variety of light-emitting materials or devices may be utilized, including LEDs, incandescent bulbs, and other light-emitting devices. Also, luminescent materials, such as phosphor-based materials, including luminescent paints, dyes, plastics and other materials may be used in the construction of the container or attached to portions of the container to enhance visibility.

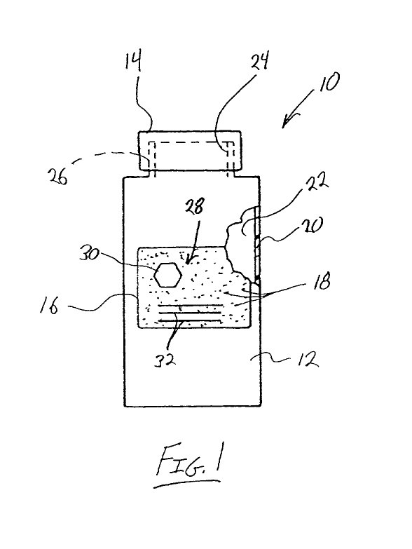

Referring generally to FIG. 1, a device 10, e.g. a container, is illustrated according to one exemplary embodiment of the present invention. Container 10 comprises a container body 12 and a cover portion 14. Container 10 also may include a label 16 formed with, printed on, attached to or otherwise applied to container body 12 and/or cover portion 14. Container 10 also comprises a light-emitting region 18.

Container body 12 may be made from a variety of materials, such as plastic, glass or other suitable materials. In some applications, plastic can be advantageous because a phosphor-based material may be mixed with the plastic to create a luminescence for light-emitting region 18. In the illustrated embodiment, container body 12 includes an outer wall 20 that forms a hollow interior region 22. The container also includes an opening 24 that provides access to hollow interior region 22. In the exemplary embodiment, opening 24 is formed through a neck region 26 of container body 12.

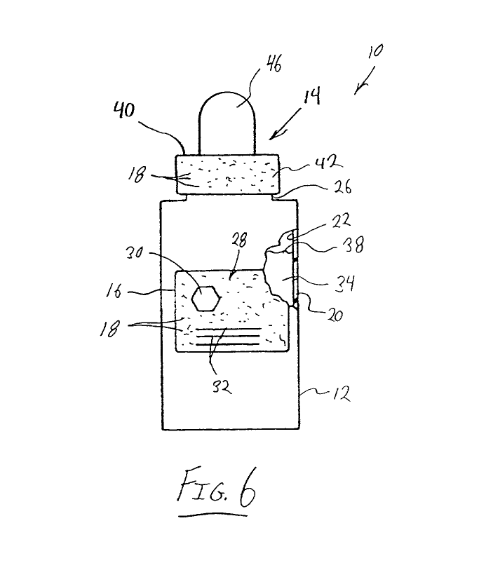

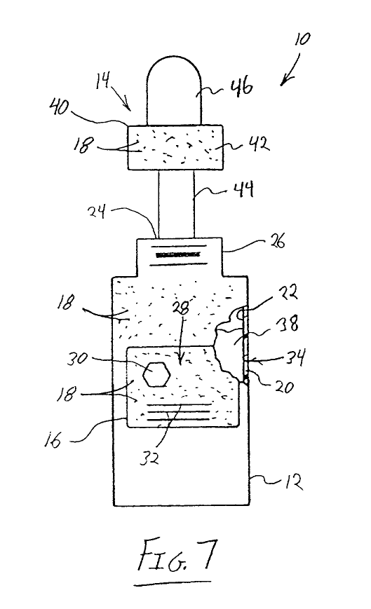

Cover portion 14 typically is designed to close opening 24. For example, cover portion 14 may engage neck region 26 to cover opening 24. The engagement of cover portion 14 with neck region 26 can be accomplished in a variety of ways known to those of ordinary skill in the art, such as threaded engagement or a variety of safety-cap style engagements. Also, different types of cover portions can be utilized, including the cap illustrated in FIG. 1 or the dropper illustrated in FIGS. 6 and 7.

The optional label 16 is used to provide selected information 28, such as company logos 30 and printed information 32, e.g. drug content and directions for use. In the embodiment illustrated in FIG. 1, label 16 is located on container body 12 and light-emitting region 18 is incorporated with label 16 to illuminate logos 30 and printed information 32. However, light-emitting region 18 can be located in a variety of other or additional areas.

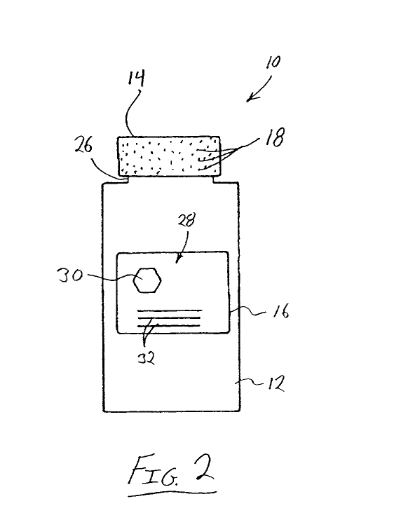

For example, light-emitting region 18 may be formed on, as part of or internal to cover portion 14, as illustrated best in FIG. 2. This permits the illumination of cover portion 14 to render container 10 more visible. Additionally, it may be advantageous to illuminate a cover portion having a specific color. For example, certain types of drugs for a given medical procedure are placed in containers having caps of a specific color to designate the particular medicinal substance disposed within the container. Certain exemplary colors comprise purple, yellow and green. The purple color, for instance, can be used as an indication of certain ophthalmological substances disposed within container 10. In one exemplary embodiment, light-emitting 18 is a luminescent region disposed on or within cover portion 14 such that the cover portion 14 luminesces in the desired color.

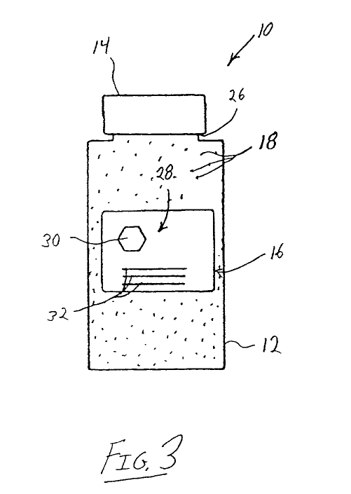

In another embodiment, illustrated in FIG. 3, light-emitting region 18 is disposed on, as part of or within container body 12. For example, if container body 12 is made of a plastic material, a phosphor-based substance may be mixed with the plastic material to create a luminescent container body 12. In other exemplary applications, a luminescent material is applied to the exterior surface of container body 12 e.g. by dyes or paints. Alternatively, a variety of lights can be attached to or disposed within container body 12. It should be noted that the light-emitting region 18 may be restricted to certain portions of container body 12, cover portion 14 and/or label 16. Also, the entire container 10 can be made as a light-emitting, luminescent, container.

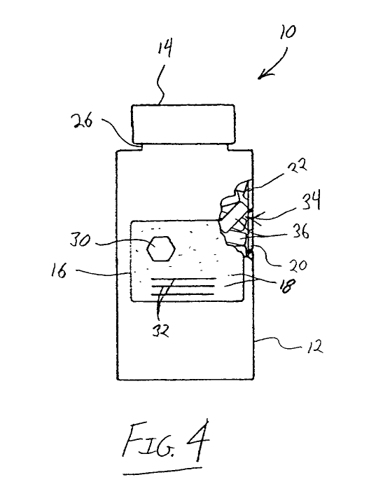

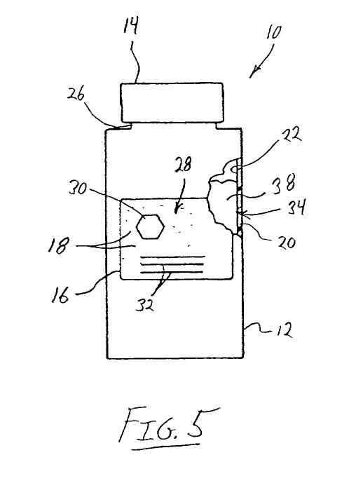

As illustrated best in FIG. 4, container 10 is designed to hold a substance within hollow interior 22, such as a medicinal substance 34. Medicinal substance 34 may be prepared in a variety of forms, such as individual portions 36, e.g. tablets, capsules, lozenges, particles, powder, etc. Additionally, medicinal substance 34 may be prepared as a liquid 38 (see FIG. 5).

The ingredients of medicinal substance 34 will vary depending on the desired use or treatment for which the substance is prepared. However, because of the greater visibility of container 10, the overall container is particularly amenable for use in holding medicinal substances used in the treatment of eyes. As discussed above, a variety of medical practitioners that work in the treatment of various eye related ailments perform certain procedures in dimly lit or dark rooms where a light-emitting container would be highly beneficial.

Accordingly, the present invention is particularly amenable with medicinal substances that comprise, for example, various ophthalmological compositions used in the treatment of glaucoma. Some exemplary medical substances comprise prostamides or a travopost ophthalmic solution. Such medicinal substances are distributed under various brand names. For example, Lumigan™ is a new drug distributed by Allergan for use in the treatment of glaucoma. Lumigan™ generally belongs to a group of IOP-lowering drugs known as prostamides. These and other medicinal substances may be readily contained within the container system described herein.

When the medicinal substance 35 is in a liquid form, it may be beneficial to design cover portion 14 as a dropper 40 (see FIGS. 6 and 7). An exemplary dropper 40 includes a retention ring 42 for mounting dropper 40 on neck region 26 over opening 24. Dropper 40 also includes a hollow draw tube 44 into which liquid 38 is drawn by compressing and releasing a resilient hollow bulb 46. Thus, the liquid medicinal substance may be drawn into draw tube 44 and dispensed where needed, e.g. the surface of an eye, by squeezing bulb 46 to expel the liquid.

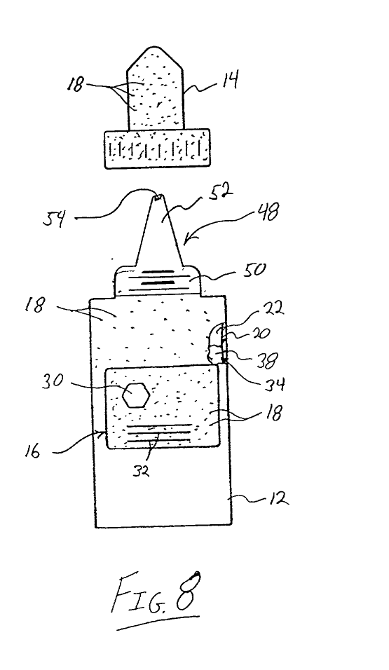

In an alternate embodiment, a dropper 48 is integrated with container body 12, as illustrated in FIG. 8. The exemplary dropper 48 includes an attachment region 50 for receiving cover portion 14 by, for instance, threaded engagement. Dropper 48 also includes an application tube 52 generally disposed over the region of opening 24. Application tube 52 also includes a droplet dispensing opening 54 disposed generally at the tip of application tube 52 opposite attachment region 50. Opening 54 is designed to permit application of medicinal substance 34, e.g. liquid 38, from hollow interior region 22. As with the other embodiments, light-emitting region 18 may be located at one or more of cover portion 14, body portion 12 or label 16.

It will be understood that the foregoing description is of preferred exemplary embodiments of this invention, and that the invention is not limited to the specific forms shown. For example, the container may be designed in a variety of shapes and configurations; various materials may be used in construction of the container components; and a variety of light-emitting devices and/or substances may be incorporated into the container to provide for the emission of light. These and other modifications may be made in the design and arrangement of the system and method without departing from the scope of the invention as expressed in the appended claims.

What is claimed is:

1. A device for holding a medication, comprising:
a container body having a hollow interior region and an opening providing access to the hollow interior region;
a cover portion disposed generally over the opening;
a medicinal substance disposed within the hollow interior region; and
a luminescent portion disposed in a readily viewable location.

2. The device as recited in claim 1, wherein the luminescent portion comprises a label disposed on the container body.

3. The device as recited in claim 1, wherein the luminescent portion is integrally formed with the container body.

4. The device as recited in claim 3, wherein the luminescent portion is disposed throughout the container body.

5. The device as recited in claim 1, wherein the luminescent portion is integrally formed with the cover portion.

6. The device as recited in claim 5, wherein the luminescent portion is disposed throughout the cover portion.

7. The device as recited in claim 5, wherein the cover portion comprises a cap.

8. The device as recited in claim 5, wherein the cover portion comprises a dropper.

9. The device as recited in claim 5, wherein the container body comprises a dropper.

10. The device as recited in claim 5, wherein the cover portion is a desired color and the luminescent portion luminesces in the desired color.

11. The device as recited in claim 10, wherein the desired color is purple.

12. The device as recited in claim 10, wherein the desired color is yellow.

13. The device as recited in claim 10, wherein the desired color is green.

14. The device as recited in claim 1, wherein the medicinal substance comprises a prostamide.

15. The device as recited in claim 1, wherein the medicinal substance comprises a travopost ophthalmic solution.

16. The device as recited in claim 1, wherein the medicinal substance comprises an ophthalmological composition for topical treatment of glaucoma.

17. A device for holding a medication, comprising:
a container system that emits light to provide greater visibility, the container system enclosing a medicinal substance.

18. The device as recited in claim 17, wherein the container system comprises a container body having a hollow interior region for holding the medicinal substance; and a cover portion to enclose the hollow interior region.

19. The device as recited in claim 17, wherein light is emitted from the cover portion.

20. The device as recited in claim 18, wherein light is emitted from the container body.

21. The device as recited in claim 18, further comprising a label disposed on the container body, wherein light is emitted from the label.

22. The device as recited in claim 17, wherein the medicinal substance comprises an ophthalmological solution.

23. The device as recited in claim 19, wherein the medicinal substance comprises an ophthalmological solution.

24. The device as recited in claim 20, wherein the medicinal substance comprises an ophthalmological solution.

25. The device as recited in claim 21, wherein the medicinal substance comprises an ophthalmological solution.

26. A method of making a medicinal container more visible in a low light or no light conditions, comprising:
placing a medicinal substance within a container; and
emitting light from at least a portion of the container to make the container more visible to an individual.

27. The method as recited in claim 26, wherein emitting light comprises forming at least a portion of the container with a luminescent material.

28. The method as recited in claim 27, wherein forming comprises forming a container cap by adding a luminescent material.

29. The method as recited in claim 27, wherein forming comprises adding a luminescent material to at least a portion of a container body.

30. The method as recited in claim 26, wherein placing comprises placing an ophthalmological solution for the treatment of glaucoma within the container.

31. The method as recited in claim 27, wherein placing comprises placing an ophthalmological solution for the treatment of glaucoma within the container.
